(19) United States
(12) Patent Application Publication
(10) Pub. No.: US 2021/0344101 A1
(43) Pub. Date: Nov. 4, 2021

(54) A Probe-fed Antenna for Bluetooth Loudspeakers

(71) Applicant: Innovation Sound Technology Co., LTD., Guangdon (CN)

(72) Inventors: Shun Ming YUEN, Guangdong (CN); Wai Yin MUNG, Guangdong (CN); Ka Ming WU, Guangdong (CN)

(21) Appl. No.: 16/631,302

(22) PCT Filed: Feb. 15, 2019
(86) PCT No.: PCT/CN2019/075230

§ 371 Date: Jan. 15, 2020

(30) Foreign Application Priority Data
Jan. 25, 2019 (CN) 201920127384.1

(51) Int. Cl. H01Q 1/22; H01Q 1/36; H04R 1/02

(52) U.S. Cl. CPC H01Q 1/2291; H04R 2420/07; H04R 1/02; H01Q 1/36

(57) ABSTRACT

The utility model belongs to the technical field of antennas, and discloses a probe-fed antenna for Bluetooth speakers, which comprises a casing, loudspeaker, a PCB, a bracket and an antenna. The bracket is fixed inside the said casing, and the loudspeaker is fixed in the middle of the bracket. The antenna, is fixed between the top of the loudspeaker and one end of the bracket. The PCB is fixed between the bottom of the loudspeaker and the other end of the bracket. The PCB in the utility model is placed on the bottom of the bracket, and the antenna is placed on the top of the bracket. In this way, the PCB and the antenna ere kept away from the loudspeaker, such that the product can achieve the smallest size and the best signal transmission/reception effect. At the same time, the antenna is placed on the top of the bracket. Generally, most casings are made of plastic, not metal because it will not affect the antenna effect. Such a design can change the antenna into a part of the metal casing.

### FIELD OF THE INVENTION

The utility model particularly relates to a probe-fed antenna for Bluetooth loudspeakers, and belongs to the technical field of antennas.

### BACKGROUND OF THE INVENTION

The traditional probe feeding is achieved by an input point, which cannot be too long. A great length will cause loss or affect the antenna effect because if the input point of the probe is too long, it will become a part of the antenna, which affects the structure of the antenna design itself. Today's Bluetooth speakers consider portability as a selling point because most of the space is used to place a good-quality loudspeaker. The larger the diameter of a loudspeaker, the better the low-frequency sound quality. However, a loudspeaker is magnetic. If a wireless circuit or an antenna is placed behind a speaker, the speaker will affect wireless signal.

### CONTENT OF THE UTILITY MODEL

The technical problem to be solved by the utility model is to overcome the existing defect and to provide a probe-fed antenna for Bluetooth loudspeakers. The PCB in the utility model is placed on the bottom of the bracket, and the antenna is placed on the top of the bracket. In this way, the PCB and the antenna are kept away from the loudspeaker, such that the product can achieve the smallest size and the best signal transmission/reception effect. At the same time, the antenna is placed on the top of the bracket. Generally, most casings are made of plastic, not metal, because it will not affect the antenna effect. Such a design can change the antenna into a part of the metal casing, and can effectively solve the problem presented in the Background of the Invention above.

In order to solve the above technical problems, the present utility model provides the following technical proposals:

The utility model provides a probe-fed antenna for Bluetooth loudspeakers, which comprises a casing, a loudspeaker, a PCB, a bracket and an antenna. The bracket is fixed inside the said casing, and the loudspeaker is fixed in the middle of the bracket. The antenna, is fixed between the top of the loudspeaker and one end of the bracket. The PCB is fixed between the bottom of the loudspeaker and the other end of the bracket.

As a preferred technical proposal for the present utility model, the said bracket is made of two parallel metal wires as transmission line for the probe-fed antenna.

As a preferred technical proposal for the present utility model, the periphery of the said metal wire is coated with a layer of antistatic paint.

As a preferred technical proposal for the present utility model, the said casing may be made of metal.

The PCB in the utility model is placed on the bottom of the bracket, and the antenna is placed on the top of the bracket. In this way, the PCB and the antenna are kept away from the loudspeaker, such that the product can achieve the smallest size and the best signal transmission/reception effect. At the same time, the antenna is placed on the top of the bracket. Generally, most casings are made of plastic, not metal, because it will not affect the antenna effect. Such a design can change the antenna into a part of the metal casing.

### BRIEF INTRODUCTION OF THE DRAWINGS

The drawings are intended to provide a further understanding of the utility model, to constitute a part of the specification of the utility model, and to explain the utility model together with the embodiments of the utility model, all of which do not constitute a limitation on the utility model.

In the drawings:

FIG. 1 is a schematic diagram for the overall structure of a probe-fed antenna for Bluetooth loudspeakers according to the embodiment in the present utility model.

FIG. 2 is a schematic structural diagram for the casing and bracket of a probe-fed antenna for Bluetooth loudspeakers according to the embodiment in the present utility model.

FIG. 3 is a schematic structural diagram for the parallel transmission line as the bracket of a probe-fed antenna for Bluetooth loudspeakers according to the embodiment in the present utility model.

FIG. 4 shows the test result of the parallel transmission line as the bracket according to the embodiment in the present utility model when r=1 mm and d=2 mm.

Numbers in the figure: 1. Casing; 2. Speaker; 3. PCB; 4. Bracket; 5. Antenna.

### DETAILED DESCRIPTION OF THE PREFERRED EMBODIMENTS

The preferred embodiments of the present utility model are described below with reference to the accompanying drawings. It shall be understood that the preferred embodiments described herein are for explanatory and illustrative purposes only, and are not intended to limit the present utility model.

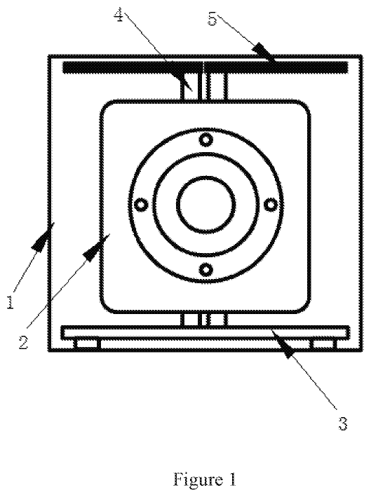

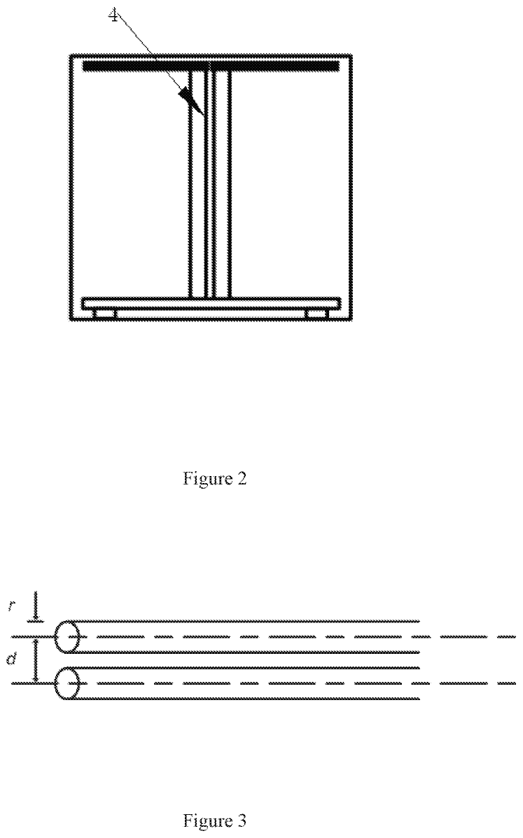

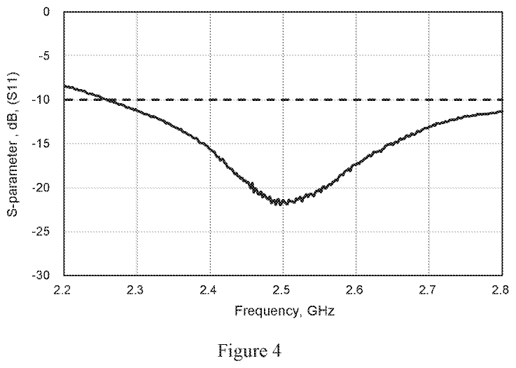

Embodiment: With reference to FIGS. 1-4, the utility model provides a probe-fed antenna for Bluetooth loudspeakers, which comprises a casing (1), a loudspeaker (2), a PCB (3), a bracket (4) and an antenna (5). The bracket (4) is fixed inside the said casing (1), and the loudspeaker (2) is fixed in the middle of the bracket (4). The antenna (5) is fixed between the top of the loudspeaker (2) and one end of the bracket (4). The PCB (3) is fixed between the bottom of the loudspeaker (and the other end of the bracket (4). The said bracket (4) is made of two parallel metal wires; the periphery of the said metal wire is coated with a layer of antistatic paint; the said casing may be made of metal. The antenna can operate at the working frequency of Bluetooth wireless signal (approximately 2.4 GHz to 2.5 GHz). FIG. 4 shows the test results of S-parameter S₁₁ with the transmission line as bracket 4 when r=1 mm and d=2 mm (r is the radius of a metal wire and d is the distance between two metal wires.)

It shall be noted that the utility model involves a probe-fed antenna for Bluetooth loudspeakers. When put into service, the PCB in the utility model is placed on the bottom of the bracket, and the antenna is placed on the top of the bracket. In this way, the PCB and the antenna are kept away from the loudspeaker, such that the product can achieve the smallest size and the best signal transmission/reception effect. At the same time, the antenna is placed on the top of the bracket. Generally, most casings are made of plastic, not metal, because it will not affect the antenna effect. Such a design can change the antenna into a part of the metal casing.

Finally, it shall be noted that the above description is only a preferred embodiment of the present utility model, and is not intended to limit the present utility model. Although the present utility model has been described in detail with reference to the stated embodiments, for those skilled in the art, it is still possible to modify the technical scheme described in the stated embodiments, or to make an equivalent substitution to some of the technical features. Any modifications, equivalent substitutions, improvements, etc. made within the spirit and scope of the present utility model shall be included within the scope of protection of the present utility model.

1. A probe-fed antenna for Bluetooth loudspeakers comprising a casing, a loudspeaker, a PCB, a bracket, and an antenna, wherein the bracket is fixed inside the casing, and the loudspeaker is fixed in the middle of the bracket; the antenna is fixed between the top of the loudspeaker and one end of the bracket; the PCB is fixed between the bottom of the loudspeaker and the other end of the bracket.

2. A probe-fed antenna for Bluetooth loudspeakers according to claim 1, wherein the bracket is made of two parallel metal wires as transmission line for the probe-fed antenna.

3. A probe-fed antenna for Bluetooth loudspeakers according to claim 2, wherein the periphery of the metal wire is coated with a layer of antistatic insulating paint.

4. A probe-fed antenna for Bluetooth loudspeakers according to claim 1, wherein the casing may be made of metal.
